(19) United States
(12) Patent Application Publication
(10) Pub. No.: US 2009/0130593 A1
(43) Pub. Date: May 21, 2009

(54) STABILIZER FOR ENHANCING PERFORMANCE OF OPTICAL RECORDING LAYER AND HIGH DENSITY OPTICAL RECORDING MEDIUM USING THE SAME

(75) Inventors: Ming-Chia Li, Taichung County (TW); An-Tze Lee, Taipei County (TW); Chien-Liang Huang, Taoyuan County (TW); Kuo-Chi Chiu, Hsinchu County (TW); Tzuan-Ren Jeng, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 11/941,094

(22) Filed: Nov. 16, 2007

(51) Int. Cl. G11B 7/244

(52) U.S. Cl. 430/270.11

(57) ABSTRACT

A recording dye layer for recording high density information and reproduction/playback of the high density information recordings is provided. The recording dye layer includes a chemical composition including a diimonium salt and or ammonium compound and a metal-azo complex for a high density optical recording medium that may effectively promote the stability and the durability of the optical recording dye layer.

### BACKGROUND OF THE INVENTION

1. Field of the Invention

The present invention generally relates to a high density optical recording medium. More particularly, the present invention relates to a stabilizer suitable for enhancing the performance of an optical recording layer suitable for a high density optical recording medium.

2. Description of Related Art

In recent years, development of optical recording media employing laser have been remarkable. An example of the optical recording medium, such as an optical disc, is generally designed to irradiate a focused laser beam of about 1 μm to a thin recording layer formed on a disc shaped substrate to conduct information recording. The recording is implemented in a manner that upon absorption of the laser beam energy, the irradiated portion of the recording layer undergoes a thermal deformation such as decomposition, evaporation or melting. Reproduction of the recorded information is carried out by reading the difference in the reflectance between the portion having a deformation formed by the laser beam and the portion without such deformation.

Accordingly, an optical recording medium is required to efficiently absorb the energy of the laser beam, and is also required to have a predetermined amount of absorbed light to a laser beam having a specific wavelength employed for recording and to be high in the reflectance to laser beam having a specific wavelength employed for reproduction for accurately conducting the reproduction of information.

It is however desirable that the performance and the efficiency of the phase change recording layer must be at an acceptable optimal level. The storage capacity of the optical recording medium employing the laser source is limited due to optical diffraction. At present, some principles and methods of enhancement of the storage density of the optical information storage media are being set forth, including such as shifting of the wavelength of the laser source, for example, from red laser to blue laser, or enhancement of the objective numerical aperture (“NA”) of optical lens. Some other methods include improvement of the encoding methods of the digital signal, or a disc storage method using an extra-fine resolution near field optical structure, or a technology for increasing the storage capacity of the information storage media (e.g., a compact disc) by using stacked multiple recording layers, i.e., the recording layers of the information storage media is developed into a three dimensional space multilayer structure, to increase the storage capacity. All the methods described above may be employed to effectively increase the storage capacity of the optical recording medium.

In the method of the shifting to shorter wavelength laser source, a new generation of a high density disc storage specification (Blue-ray Disc) is published in 2002 by companies such as Hitachi, LG, National, Pioneer, Philips, Samsung, Sharp, Sony and Thomson Multimedia in common. A single-side Blue-ray Disc may be promoted up to 27 GB by employing a 405 nm blue laser source and a 0.1 mm optical transmission cover layer structure.

The recording dye layer can be easily formed by a coating method and shows a high sensitivity, as compared with the recording metal layer. However, higher sensitivity to blue laser for recording and the high read stability is required for the property of organic dye for blue laser recording. These properties have a trade-off relationship each other. The recording dye layer cannot satisfy the desirous characteristics such as a larger number of times of reproduction, or enhancement of a total performance of the recording dye layer. The drawbacks are mainly caused by poor stability of the composition of the material of the recording dye layer. Therefore, it is highly desired to develop a recording dye layer having stable recording and reproducing characteristics for a long time.

Accordingly, it is desirous to develop a composition for a recording dye layer having stable recording and reproducing characteristics for a long time and thereby enhance the performance of the optical recording layer, for example, substantially increasing the number of times of reproduction of stored recordings.

### SUMMARY OF THE INVENTION

Accordingly, the present invention is directed to a chemical composition suitable for promoting the stability of an optical recording dye layer such that the number of times of reproduction of stored recordings can be effectively increased.

The present invention provides a recording dye layer suitable for an optical recording medium for recording information and reproduction/playback of the information recordings including at least the chemical composition.

According to an embodiment of the present invention, the chemical composition includes a mixture of a diimonium salt and or ammenium compound and a metal-azo complex.

According to an embodiment of the present invention, the diimonium salt has the following general chemical structural formula (I):

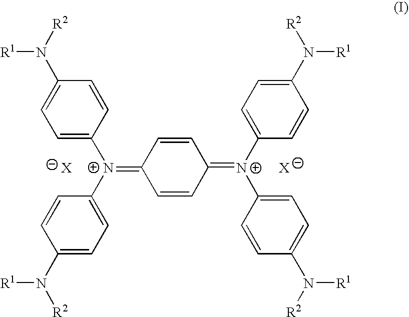

wherein R¹ and R² represent substituted or non-substituted alkyl group and X represents a divalent organic anion having two sulfonic acid groups within its molecule, halogen atom, ClO₄⁻, BF₄⁻, PF₆⁻, SbF₆⁻, TCNQ⁻, TCNE⁻, naphthalenesulfonic acid, polymethine anion or organometallic complex.

According to an embodiment of the present invention, the ammenium compound has the following general chemical structural formula (II):

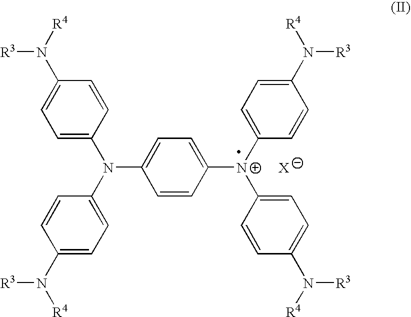

wherein R³ and R⁴ represent substituted or non-substituted alkyl group and X represents halogen atom, ClO₄⁻, BF₄⁻, PF₆⁻, SbF₆⁻, TCNQ⁻, TCNE⁻, naphthalenesulfonic acid, polymethine anion or organometallic complex.

According to an embodiment of the present invention, the metal-azo complex has the following general chemical structural formula (III) or (IV):

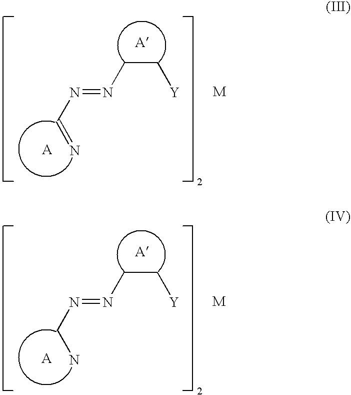

wherein ring A represents an heterocyclic ring having at least one substituent, ring A′ represents an aromatic hydrocarbon ring, an aromatic heterocyclic ring or a condensed ring including a saturated aromatic hydrocarbon ring, wherein the aromatic hydrocarbon ring, the aromatic heterocyclic ring or the condensed ring have at least one substituent, wherein Y is selected from O⁻, NH⁻, NSO₂R⁻, COO⁻ or SO₃⁻, wherein R represents substituted or non-substituted alkyl group. M is a divalent metal including Fe, Co, Cu, Ni, Mg Al, Pt, Pd, Cr, Mn, or Zn.

The chemical composition of the present invention can be employed for, for example, improving the stability of a recording dye layer of an optical recording medium. Because the chemical composition of the present invention, when included in the recording dye layer, may substantially increase the stability of the recording dye layer, it is possible to increase the stability of the recording marks formed thereon and thereby increase the number of times of reproduction of the stored recordings. The recording dye layer including the chemical composition of the present invention is suitable for a high density recording medium for recording high density information and reproduction/playback of the high density information recordings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a cross sectional view of a high density optical recording medium according to an embodiment of the present invention.

### DESCRIPTION OF THE INVENTION

It is to be understood that both the foregoing general description and the following detailed description are exemplary, and are intended to provide further explanation of the invention as claimed.

The present invention provides a chemical composition suitable for improving the stability of a recording dye layer used for fabricating a high density optical recording medium for recording high density information and reproduction/playback of the high density information recordings, such as HD-DVD-R, BD-R, and the like. The chemical composition comprises a mixture of a diimonium salt and or ammenium and a metal-azo complex.

According to an embodiment of the present invention, the diimonium salt comprises the following general chemical structural formula (I):

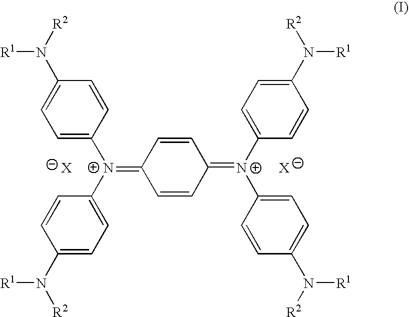

wherein R¹ and R² represent substituted or non-substituted alkyl group and X represents a divalent organic anion having two sulfonic acid groups within its molecule, halogen atom, ClO₄⁻, BF₄⁻, PF₆⁻, SbF₆⁻, TCNQ⁻, TCNE⁻, naphthalenesulfonic acid, polymethine anion or organometallic complex.

According to an embodiment of the present invention, the ammenium compound has the following general chemical structural formula (II):

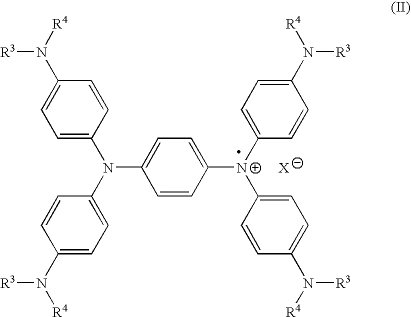

wherein R³ and R⁴ represent substituted or non-substituted alkyl group and X represents halogen atom, ClO₄⁻, BF₄⁻, PF₆⁻, SbF₆⁻, TCNQ⁻, TCNE⁻, naphthalenesulfonic acid polymethine anion or organometallic complex.

According to an embodiment of the present invention, the metal-azo complex has the following general chemical structural formula (III) or (IV):

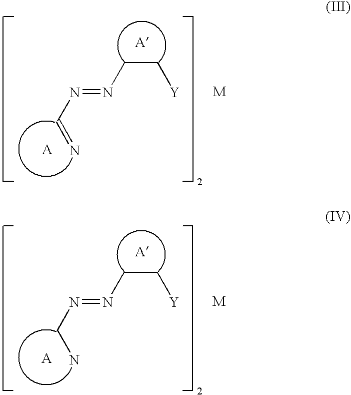

wherein ring A represents an heterocyclic ring having at least one substituent, ring A′ represents an aromatic hydrocarbon ring, an aromatic heterocyclic ring or a condensed ring including a saturated aromatic hydrocarbon ring, wherein the aromatic hydrocarbon ring, the aromatic heterocyclic ring or the condensed ring have at least one substituent, wherein Y is selected from O⁻, NH⁻, NSO₂R⁻, COO⁻ or SO₃⁻, wherein R represents substituted or non-substituted alkyl group. M is a divalent metal including Fe, Co, Cu, Ni, Mg Al, Pt, Pd, Cr, Mn, or Zn.

Following are some of the specific derivatives of the organic dye (U.S. application Ser. No. 11/672,378) of the present invention. However, these examples are not intended to limit the scope of the present invention as such.

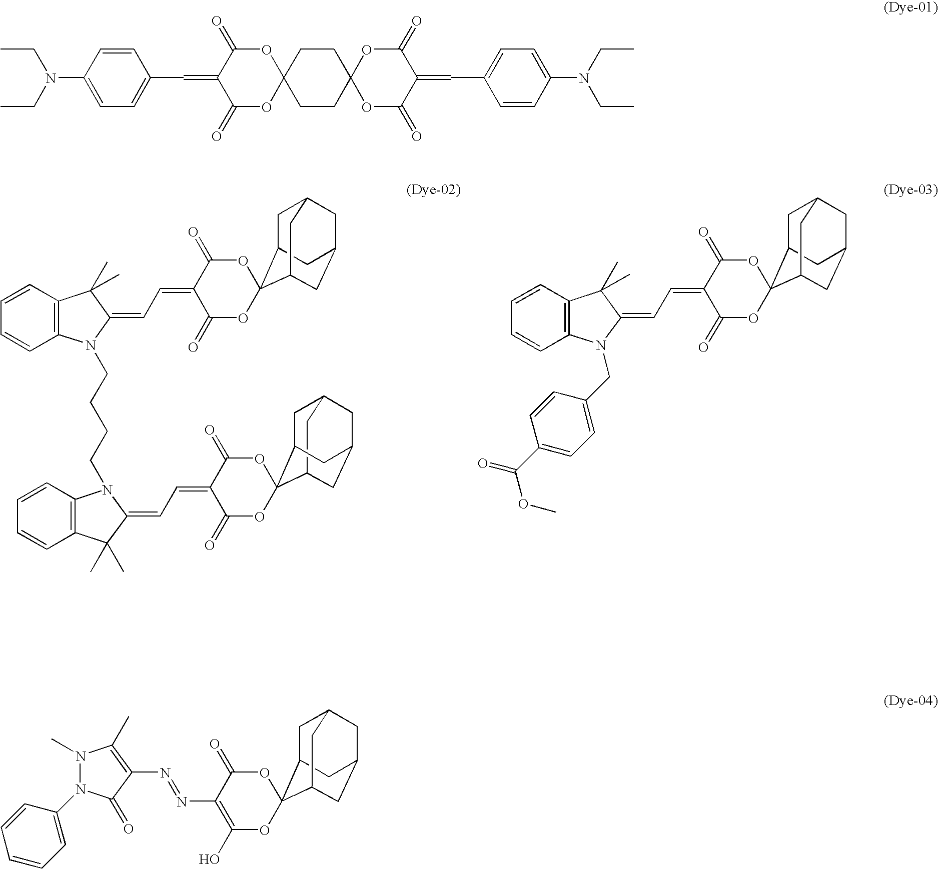

Following are some of the specific derivatives of the diimonium salt (I) of the present invention. However, these examples are not intended to limit the scope of the present invention as such.

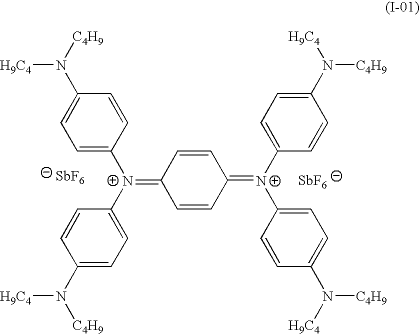

Following are some of the specific derivatives of ammenium compound (II) of the present invention. However, these examples are not intended to limit the scope of the present invention as such.

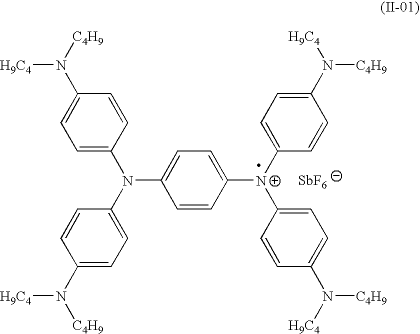

Following are some of the specific derivatives of metal-azo complexes (III) of the present invention. However, these examples are not intended to limit the scope of the present invention as such.

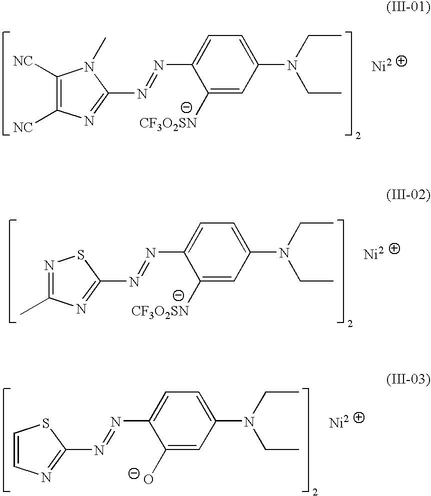

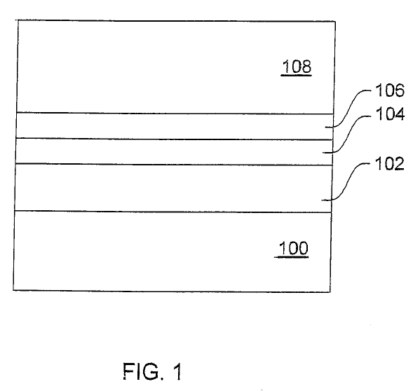

Hereinafter, a structure of a high density optical recording medium will be described with reference to FIG. 1 as follows. Referring to FIG. 1, the high density optical recording medium comprises a first substrate 100, a cover layer 108 and at least a recording dye layer 102 disposed between the first substrate 100 and the cover layer 108. Furthermore, a reflective layer 106 may be provided on the recording dye layer 102 and also, if necessary, a primer reflective layer may be provided on the first substrate 100, a protective layer 104 may be provided on the recording dye layer 102 or the reflective layer 106, and a surface protective layer may be provided on the first substrate 100 at the opposite side to the recording dye layer 102.

According to an aspect of the present invention, the recording dye layer 102 comprises at least a chemical composition comprising a diimonium salt and or ammenium compound and a metal-azo complex.

According to an embodiment of the present invention, the diimonium salt comprises the general chemical structural formula (I).

According to an embodiment of the present invention, the ammenium compound comprises the general chemical structural formula (II).

According to an embodiment of the present invention, the metal-azo complex comprises the following general chemical structural formula (III) or (IV).

According to an aspect of the present invention, the first substrate 100 and the cover layer 108 are preferably transparent to the laser beam. The material of the first substrate 100 and the cover layer 108 may be comprised of, for example but not limited to, glass or plastic materials. From various aspects, the plastic material is preferably used. The plastic material may be comprised of, for example but not limited to, polycarbonate (PC), polymethylmethacrylate (PMMA), polymer resins, glass, acryl resin, methacryl resin, vinyl acetate resin, vinyl chloride resin, nitro cellulose, polyethylene resin, polypropylene resin, polycarbonate resin, polyimide resin, epoxy resin, polysulfone resin and metallocene based cyclic olefin copolymer (mCOC). Among the plastic materials mentioned above, an injection molded polycarbonate resin substrate may of particular interest from the viewpoint of the high productivity, low cost and moisture resistance. The thickness of the first substrate 100 may be between 0.5 mm to 1.3 mm, more preferably about 0.6 mm. Even though not illustrated, the first substrate 100, for example, comprises lands, or pre-curved pits or grooves with a track pitch of less than 0.4 μm. The lands, or pre-curved pits or grooves in the first substrate 100 are used to provide a signal surface for the laser tracking of the pick-up head of the laser.

According to an aspect of the present invention, the recording dye layer 102 of the present invention containing at least a chemical composition comprising a diimonium salt (I) and or ammenium compound (II) and the metal-azo complex (III) or (IV) is formed with a thickness in a range of about 10 Å to 500 nm, preferably in a range of about 5 nm to 200 nm. The recording dye layer 102 of the present invention may be formed by employing well known thin-film-forming methods such as a spin coating method, a roller press method, a vacuum vapor deposition method, a sputtering method, a doctor blade method, a casting method, inkjet printing method or a dipping method. However, the spin coating method is preferred from the viewpoint of the productivity and cost.

According to an aspect of the present invention, the reflective layer 106 may be comprised of, for example but not limited to, metals such as gold, silver, copper, aluminum or platinum, titanium and alloys thereof, or equivalents thereof, which have high reflectance in the laser wavelength region to be employed. The thickness of the reflective layer 106 may be about 1 nm to 300 nm. The reflective layer 106 may be formed on the recording dye layer 102 using vacuum sputtering.

Finally, the cover layer 108 may be adhered over the reflective layer 106 to complete the fabrication of the high density optical recording medium. The cover layer 108 may be adhered over the reflective layer 106 by spin coating, screen printing, thermal gluing or roller pressing process.

According to an aspect of the present invention, the surface protective layer on the mirror surface side of the first substrate may be comprised of, for example but not limited to, an ultraviolet curable acryl resin or a silicon type hard coating agent. The surface protective is preferably provided with an antistatic ability for preventing dust or the like from adhering.

The recording dye layer 102 of the present invention may be formed on one side of the first substrate 100. According to an aspect of the present invention, multiple recording dye layers may be used for fabricating a multi-layer stacked optical recording medium structure with a view of further increasing the storage capacity of the optical recording medium.

Recording on an optical recording medium thus obtained, may be conducted by irradiating a laser beam, for example a blue laser with a wavelength of 405 nm, to the recording dye layer. At the portion irradiated with the laser beam, a thermal deformation of the recording dye layer, such as decomposition, evaluation or melting may be formed due to absorption of the laser energy. Reproduction of the recorded information can be conducted by reading the difference in the reflectance between the portion having such a thermal deformation formed by a laser beam and the portion having no such a thermal deformation. The chemical composition comprising the diimonium salt (I) and or ammenium compound (II) and the metal-azo complex (III) or (IV) according to the present invention contained in the optical recording dye layer may effectively promote the stability of the optical recording dye layer before and after recording and therefore and the number of times of reproduction of the optical recording dye layer may also be substantially increased.

Thus, the optical recording dye layer exhibit higher stability and has comparatively a greater number of times of reproduction features. The recording mark will not change easily by continuous reproduction, and thus the optical recording medium excels in comparatively greater number of times of reproduction durability. Besides, this feature facilitates the pitch of tracks to be set small so that the optical recording dye layer of the present invention is also effective for high density recording.

Preparation of the Recording Dye Layer (Example 20)

0.5 g organic dye (Dye-02), 0.25 g diimonium salt (I-01) and 0.25 g metal-azo complex (III-03) were dissolved in 2,2,3,3-tetrafluoropropanol to obtain a 10 g dye solution. Then, the dye solution was spin-coated on the polycarbonate substrate to form the recording dye layer.

The reproduction characteristics of the above optical recording medium was evaluated using a PULSTEC ODU-1000 instrument under the conditions including a blue laser beam with wavelength of 405 nm, reading power of 0.4 mW, objective lens numerical aperture (NA) of 0.65, and CLV=6.61 m/s. The PRSNR is the major parameter to evaluate the recording performance of the recording dye layer, wherein PRSNR represents Partial Response Signal-to-Noise Ratio. The read-stability is the test of evaluating the degradation of the recording performance (PRSNR) due to repeated playback. The measuring techniques of PRSNR and read-stability are described in the book available from DVD Forum.

TABLE 1

| | | | | Maximum Read- |
|---|---|---|---|---|
| | | | | Stability (times) |
| Recording Layer | Dye Type | Stabilizer Type | PRSNR (Spec. >15) | (Spec. >1,000,000) |
| Example 1 | Dye-03 | NA | 26 | 1,000 |
| Example 2 | Dye-03 | I-01 (25 wt %) | 25 | 100,000 |
| | (75 wt %) | | | |
| Example 3 | Dye-03 | III-03 (25 wt %) | 26 | 50,000 |
| | (75 wt %) | | | |
| Comparative | NA | I-01 (100 wt %) | Unwritable | Undetectable |
| Example 1 | | | | |
| Comparative | NA | III-03 (100 wt %) | Unwritable | Undetectable |
| Example 2 | | | | |

As can be seen from the above Table 1, the reproduction stability of the recording dye layer is increased by adding 25 wt % of either diimonium salt (I) or 25 wt % of metal-azo complex (III) into the recording dye layer (Examples 2 and 3) compared to that not including 25 wt % of either diimonium salt (I) or 25 wt % of metal-azo complex (III) (Example 1) or those only including 25 wt % of either diimonium salt (I) or 25 wt % of metal-azo complex (III) but without the dye in the recording layer (Comparative Examples 1 and Comparative Examples 2).

TABLE 2

| | | | | Maximum Read- |
|---|---|---|---|---|
| | | | | Stability (times) |
| Recording Layer | Dye Type | Stabilizer Type | PRSNR (Spec. >15) | (Spec. >1,000,000) |
| Example 4 | Dye-03 | I-01 (25 wt %) | 25 | 100,000 |
| | (75 wt %) | | | |
| Example 5 | Dye-02 | I-01 (25 wt %) | 26 | 150,000 |
| | (75 wt %) | | | |
| Example 6 | Dye-04 | I-01 (25 wt %) | 23 | 105,000 |
| | (75 wt %) | | | |
| Example 7 | Dye-01 | I-01 (25 wt %) | 15 | 90,000 |
| | (75 wt %) | | | |
| Example 8 | Dye-03 | NA | 26 | 1,000 |
| | (100 wt %) | | | |
| Example 9 | Dye-02 | NA | 30 | 10,000 |
| | (100 wt %) | | | |
| Example 10 | Dye-04 | NA | 25 | 1,200 |
| | (100 wt %) | | | |
| Example 11 | Dye-01 | NA | 22 | 1,000 |
| | (100 wt %) | | | |

As can be seen from the above Table 2, the reproduction stability of the recording dye layer is increased by adding 25 wt % of diimonium salt (I) into the recording dye layer (Examples 4-7) compared to those including the dye but without the diimonium salt (I) or metal-azo complex (III) or (IV) in the recording layer (Examples 8-11).

TABLE 3

| | | | | Maximum Read- |
|---|---|---|---|---|
| | | | | Stability (times) |
| Recording Layer | Dye Type | Stabilizer Type | PRSNR (Spec. >15) | (Spec. >1,000,000) |
| Example 12 | Dye-02 | I-01 (0 wt %) | 30 | 10,000 |
| | (100 wt %) | | | |
| Example 13 | Dye-02 | I-01 (25 wt %) | 26 | 150,000 |
| | (75 wt %) | | | |
| Example 14 | Dye-02 | I-01 (50 wt %) | 25 | 410,000 |
| | (50 wt %) | | | |
| Example 15 | Dye-02 | I-01 (75 wt %) | 24 | 700,000 |
| | (25 wt %) | | | |
| Example 16 | Dye-02 | III-03 (25 wt %) | 25 | 100,000 |
| | (75 wt %) | | | |
| Example 17 | Dye-02 | III-03 (50 wt %) | 21 | 410,000 |
| | (50 wt %) | | | |
| Example 18 | Dye-02 | III-03 (75 wt %) | 15 | 600,000 |
| | (25 wt %) | | | |

As can be seen from the above Table 3, the reproduction stability of the recording dye layer is increased with the proportion of diimonium salt (I) or metal-azo complex (III) or (IV) added into the recording dye layer, and the reproduction stability of the recording dye layer is directly proportional to the content of either diimonium salt (I) or metal-azo complex (III) or (IV). However, the PRSNR of the recording dye layer is proportionally decreased with the amount of diimonium salt (I) or metal-azo complex (III) or (IV) added into the recording dye layer.

TABLE 4

| | | | | | Maximum |
|---|---|---|---|---|---|
| | | | | | Read-Stability |
| | | | | PRSNR | (times) |
| Recording Layer | Dye Type | Stabilizer Type | Stabilizer Type | (Spec. > 15) | (Spec. > 1,000,000) |
| Example 20 | Dye-02 | I-01 | III-03 | 30 | >1,000,000 |
| | (50 wt %) | (25 wt %) | (25 wt %) | | |
| Example 21 | Dye-02 | II-01 | III-03 | 30 | 800,000 |
| | (50 wt %) | (25 wt %) | (25 wt %) | | |

As can be seen from the above Table 4, the reproduction stability of the recording dye layer is significantly increased by adding a mixture of 25 wt % of diimonium salt (I-01) and 25 wt % of metal-azo complex (III-03) into the recording dye layer, wherein the number of times of reproduction is increased to more than 1,000,000 times, and the PRSNR of Example 20 is the same that of Example 12. Thus, it is concluded that the mixture of diimonium salt (I) and or ammenium compound (II) and metal-azo complex (III) can synergistically increase the stability and durability of the recording dye layer. Thus, the mixture of the diimonium salt (I) and or ammenium compound (II) and metal-azo complex (III) or (IV) can be synergistically more effective in increasing the reproduction stability of the recording dye layer compared to using the diimonium salt or metal-azo complex alone.

It should be noted that although the present invention is illustrated using the chemical composition including 25 wt % of diimonium salt and 25 wt % of metal-azo complex in a recording layer including 50 wt % of dye, it is however not intended to limit the scope of the present invention as such, chemical compositions including varying proportions of diimonium salt and or ammenium compound and metal-azo complex according to actual requirements may also be employed to practice the teachings of the present invention, which shall also be construed to be within the scope of the present invention.

Since the recording dye layer, incorporated with a chemical composition including the mixture of diimonium salt (I) and or ammenium compound (II) and metal-azo complex (III) or (IV), exhibits excellent stability and durability, and thereby effectively enhance the number of times of reproduction of the recording marks recorded thereon.

It will be apparent to those skilled in the art that various modifications and variations can be made to the structure of the present invention without departing from the scope or spirit of the invention. In view of the foregoing, it is intended that the pre-sent invention covers modifications and variations of this invention provided they fall within the scope of the following claims and their equivalents.

What is claimed is:

1. An optical recording dye layer for a high density optical recording medium comprising a chemical composition including at least a mixture of a diimonium salt and or ammenium compound and metal-azo complexes.

2. The optical recording dye layer according to claim 1, wherein the diimonium salt comprises a following general chemical structural formula (I): 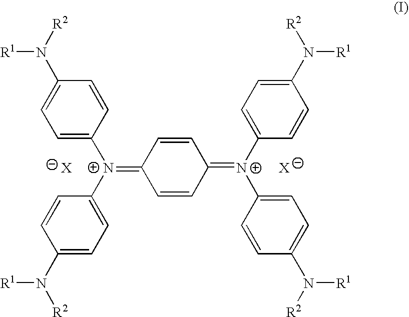
wherein R¹ and R² represent substituted or non-substituted alkyl group and X represents a divalent organic anion having two sulfonic acid groups within its molecule, halogen atom, ClO₄⁻, BF₄⁻, PF₆⁻, SbF₆⁻, TCNQ⁻, TCNE⁻, naphthalenesulfonic acid or organometallic complex.

3. The optical recording dye layer according to claim 1, wherein the ammenium compound comprises a following general chemical structural formula (II): 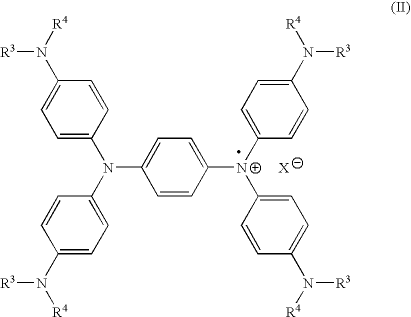
wherein R³ and R⁴ represent substituted or non-substituted alkyl group and X represents halogen atom, ClO₄⁻, BF₄⁻, PF₆⁻, SbF₆⁻, TCNQ⁻, TCNE⁻, naphthalenesulfonic acid or or ganometallic complex.

4. The optical recording dye layer according to claim 1, wherein the metalazo-complexes comprise following general chemical structural formula (III) and (IV): 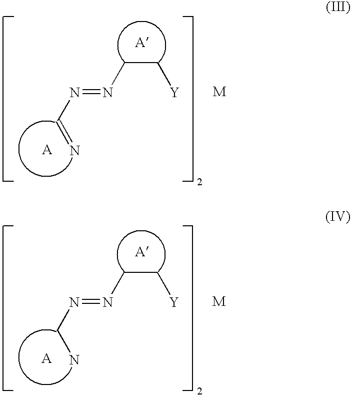
wherein ring A represents an heterocyclic ring having at least one substituent, ring A′ represents an aromatic hydrocarbon ring, an aromatic heterocyclic ring or a condensed ring including a saturated aromatic hydrocarbon ring, wherein the aromatic hydrocarbon ring, the aromatic heterocyclic ring or the condensed ring have at least one substituent, wherein Y is selected from O⁻, NH⁻, NSO₂R⁻, COO⁻ or SO₃⁻, wherein R represents substituted or non-substituted alkyl group, and wherein M is a divalent metal comprising Fe, Co, Cu, Ni, Mg Al, Pt, Pd, Cr, Mn, or Zn.

5. The optical recording dye layer according to claim 1, wherein the chemical composition comprises 10˜90 wt % of diimonium salt and or ammenium compound.

6. The optical recording dye layer according to claim 1, wherein the chemical composition comprises 10˜90 wt % of metal-azo complex.

7. A high-density optical recording medium, comprising:
a first substrate and a cover layer; and
at least a recording dye layer, disposed between the first substrate and the cover layer, wherein the recording dye layer comprises at least a chemical composition including at least a mixture of a diimonium salt and or ammenium and a metal-azo complex.

8. The high-density optical recording medium according to claim 7, wherein the diimonium salt comprises a following general chemical structural formula (I): 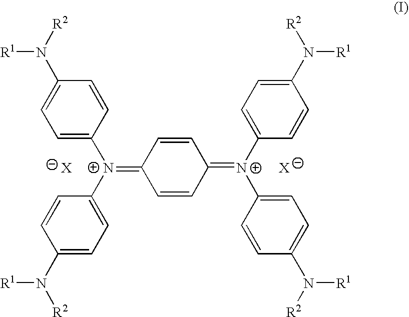
wherein R¹ and R² represent substituted or non-substituted alkyl group and X represents halogen atom, ClO₄⁻, BF₄⁻, PF₆⁻, SbF₆⁻, TCNQ⁻, TCNE⁻, naphthalenesulfonic acid or organometallic complex.

9. The high-density optical recording medium according to claim 7, wherein the ammenium compound comprises a following general chemical structural formula (II): 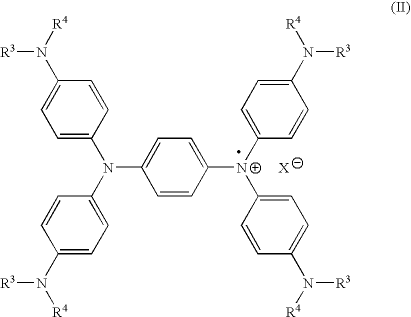
wherein R³ and R⁴ represent substituted or non-substituted alkyl group and X represents halogen atom, ClO₄⁻, BF₄⁻, PF₆⁻, SbF₆⁻, TCNE⁻, naphthalenesulfonic acid or organometallic complex.

10. The high-density optical recording medium according to claim 7, wherein the metal-azo complex comprises a following general chemical structural formula (III) and (IV): 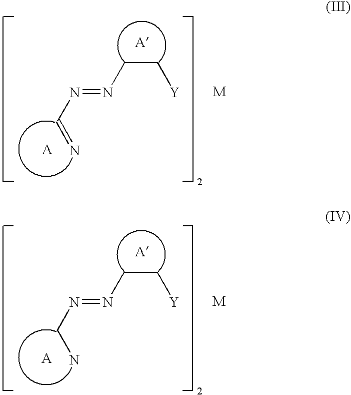
wherein ring A represents an heterocyclic ring having at least one substituent, ring A′ represents an aromatic hydrocarbon ring, an aromatic heterocyclic ring or a condensed ring including a saturated aromatic hydrocarbon ring, wherein the aromatic hydrocarbon ring, the aromatic heterocyclic ring or the condensed ring have at least one substituent, wherein Y is selected from O⁻, NH⁻, NSO₂R⁻, COO⁻ or SO₃⁻, wherein R represents substituted or non-substituted alkyl group, and wherein M is a divalent metal comprising Fe, Co, Cu, Ni, Mg Al, Pt, Pd, Cr, Mn, or Zn.

11. The high-density optical recording medium according to claim 7, wherein the chemical composition comprises 10˜90 wt % of diimonium salt and or ammenium compound.

12. The high-density optical recording medium according to claim 7, wherein the chemical composition comprises 10˜90 wt % of metal-azo complex.

13. The high-density optical recording medium according to claim 7, wherein a material of the first substrate and the cover layer is selected from a group consisting of polycarbonate (PC), polymethylmethacrylate (PMMA), polymer resins, glass, acryl resin, methacryl resin, vinyl acetate resin, vinyl chloride resin, nitro cellulose, polyethylene resin, polypropylene resin, polycarbonate resin, polyimide resin, epoxy resin, polysulfone resin and metallocene based cyclic olefin copolymer (mCOC).

14. The high-density optical recording medium according to claim 7, wherein a thickness of the first substrate is between 0.5 mm to 1.3 mm.

15. The high-density optical recording medium according to claim 7, wherein a thickness of the cover layer is between 0.01 mm to 0.7 mm.

16. The high-density optical recording medium according to claim 7, wherein the first substrate comprises a land-and-groove surface on a single side thereof.

17. The high-density optical recording medium according to claim 7, further comprising a reflective layer disposed between the cover layer and the first substrate and a material of the reflective layer is selected from a group consisting of gold, silver, copper, aluminum, platinum, titanium and alloys thereof.

18. The high-density optical recording medium according to claim 7, further comprising a protective layer disposed on the recording dye layer or the reflective layer.

19. The high-density optical recording medium according to claim 18, wherein a material of the protective layer comprises SiN, SiO₂, ZnS—SiO₂, an ultraviolet curable acryl resin or a silicon type hard coating agent.
